(19) United States
(12) Patent Application Publication
(10) Pub. No.: US 2026/0155296 A1
(43) Pub. Date: Jun. 4, 2026

(54) COIL COMPONENT

(71) Applicant: OMRON CORPORATION, Kyoto-shi, Kyoto (JP)

(72) Inventors: Yoshiyuki SATO, Kyoto-shi, Kyoto (JP); Daigoro EBISUMOTO, Kyoto-shi, Kyoto (JP); Takayuki KAWAMOTO, Kyoto-shi, Kyoto (JP); Junya MISHIMA, Kyoto-shi, Kyoto (JP)

(21) Appl. No.: 19/125,421

(22) PCT Filed: Oct. 24, 2023
(86) PCT No.: PCT/JP2023/038353

§ 371 Date: Apr. 29, 2025

(30) Foreign Application Priority Data
Nov. 1, 2022 (JP) 2022-175681

(51) Int. Cl. H01F 27/30; H01F 17/04; H01F 27/26

(52) U.S. Cl. CPC H01F 27/306; H01F 17/04; H01F 27/266

(57) ABSTRACT

To provide coil component capable of improving stability in case where core is disposed on a plurality of substrates. Coil component according to present disclosure includes a plurality of substrates, core material, and support member. The plurality of substrates each include coil pattern. The plurality of substrates stack with gap opened along thickness direction. Core material disposes on the plurality of substrates each. Support member is engaged with outer peripheral portion of the plurality of substrates to support the plurality of substrates so as to maintain gap

### TECHNICAL FIELD

The present disclosure relates to a coil component including a substrate and a core disposed on the substrate.

### BACKGROUND ART

Patent Document 1 discloses a transformer as an example of a coil component including a substrate and a core disposed on the substrate.

The transformer disclosed in Patent Document 1 includes a winding formed by winding conductive foil around a printed circuit board, and an EIR core obtained by combining an ER core and an I core. The ER core includes a flat plate portion, a central leg portion that protrudes from a central portion of the flat plate portion, and outer leg portions that protrude from both ends of the flat plate portion. The central leg portion is inserted into a central leg portion insertion hole of the printed circuit board, and the outer leg portions are inserted into outer leg portion insertion holes of the printed circuit board. The I core is disposed at a position at which the ER core is faced with the printed circuit board in between. Thus, the printed circuit board is sandwiched between the ER core and the I core.

### PRIOR ART DOCUMENT

### Patent Document

Patent Document 1: Japanese Patent No. 5788012

### SUMMARY OF THE INVENTION

### Problems to be Solved by the Invention

As a coil component, there is a coil component in which a core is disposed on a plurality of substrates stacked with a gap. For example, in a case where the coil component (transformer) disclosed in Patent Document 1 includes a plurality of printed circuit boards, leg portions of an ER core are inserted into insertion holes formed in each of the printed circuit boards. At this time, there is a risk that the coil component wobbles due to occurrence of deviation in relative positions between the plurality of substrates and occurrence of deviation in relative positions between at least one of the plurality of substrates and the core. In a coil component in which a core is installed on a plurality of substrates, stabilizing the coil component is difficult because there are many portions where deviation in relative positions occurs as compared with a coil component in which a core is installed on one substrate.

Therefore, an object of the present disclosure is to solve the above issue, and to provide a coil component capable of improving stability in a case where a core is disposed on a plurality of substrates.

### Solutions to the Problems

A coil component according to one aspect of the present disclosure includes:
a plurality of substrates each including a coil pattern and disposed with a gap there between along a thickness direction;
a core material disposed on the plurality of substrates; and
a support member that is engaged with an outer peripheral portion of the plurality of substrates to support the plurality of substrates so as to maintain the gap.

### Effects of the Invention

According to the present disclosure, a coil component capable of improving stability in a case where a core is disposed on a plurality of substrates can be provided.

### BRIEF DESCRIPTION OF THE DRAWINGS

FIG. 1 is a perspective view schematically illustrating a coil component according to one embodiment of the present disclosure.

FIG. 2 is an exploded perspective view of the coil component illustrated in FIG. 1.

FIG. 3 is a front view of the coil component illustrated in FIG. 1.

FIG. 4 is a front view of the coil component illustrated in FIG. 3 in which a support member is exploded from other parts.

FIG. 5 is a side view schematically illustrating a support member of a modification.

FIG. 6 is a front view in which a support member is replaced with a support member of a modification in the front view of FIG. 3.

FIG. 7 is a perspective view schematically illustrating a coil component of a modification according to the one embodiment of the present disclosure.

### DETAILED DESCRIPTION

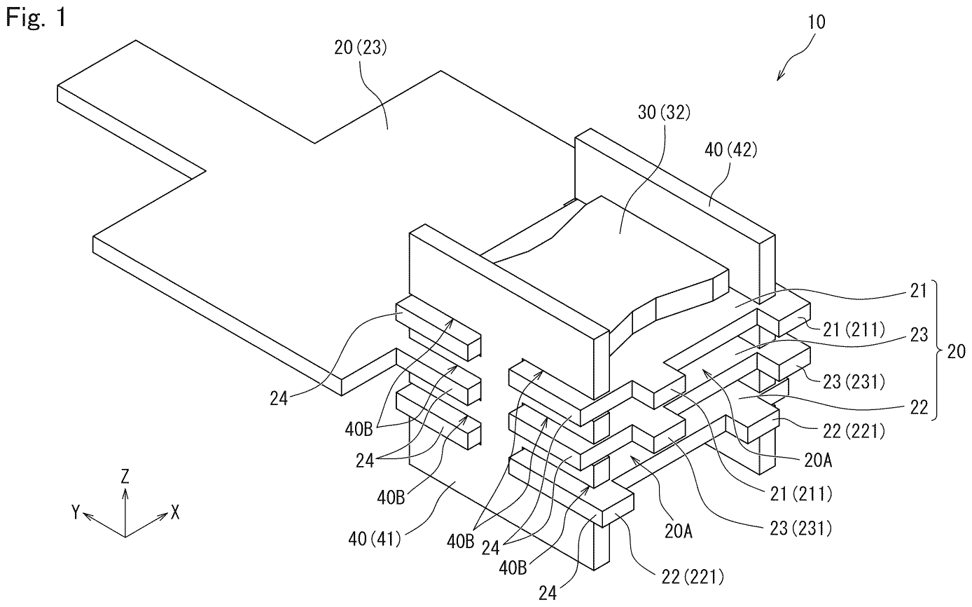

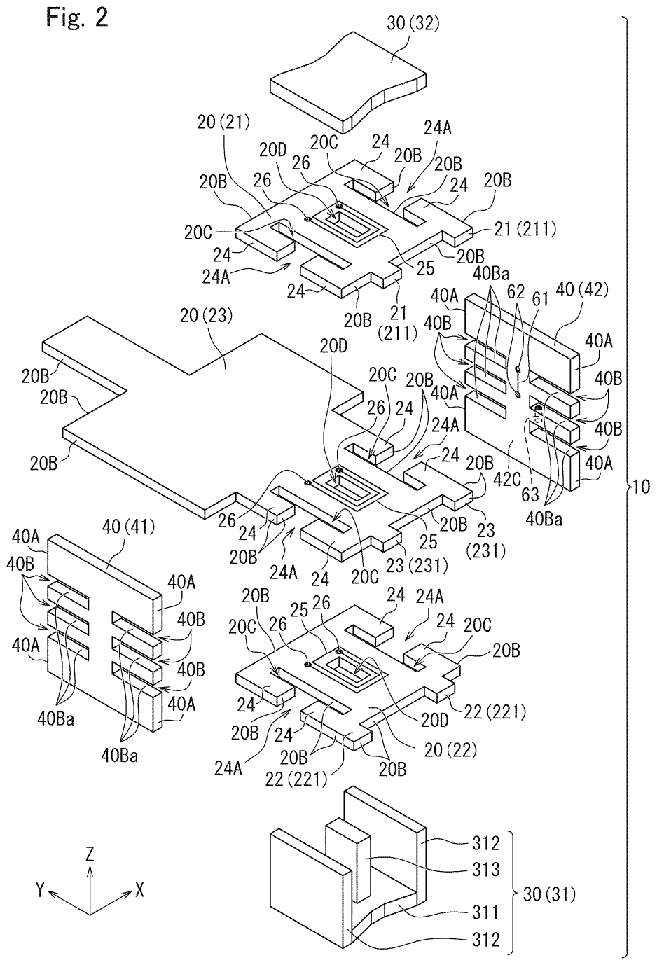

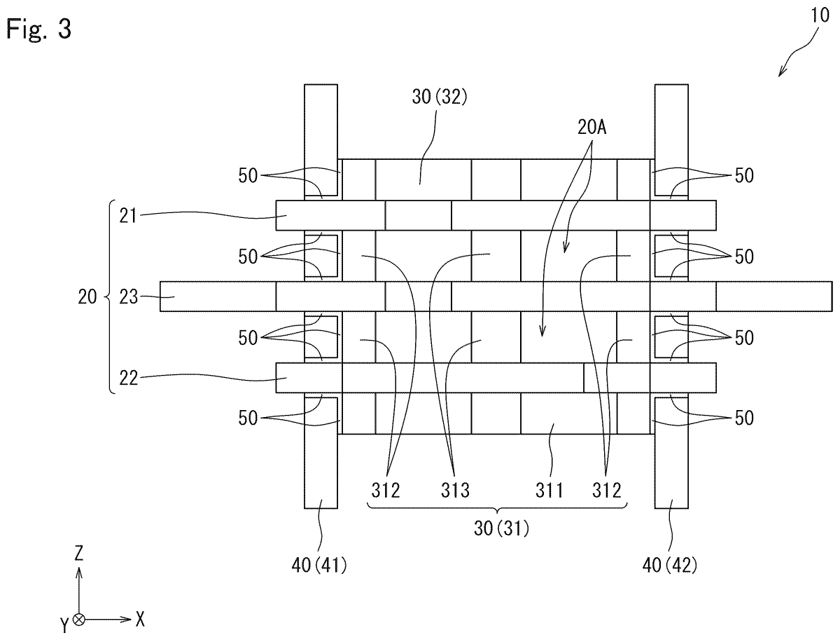

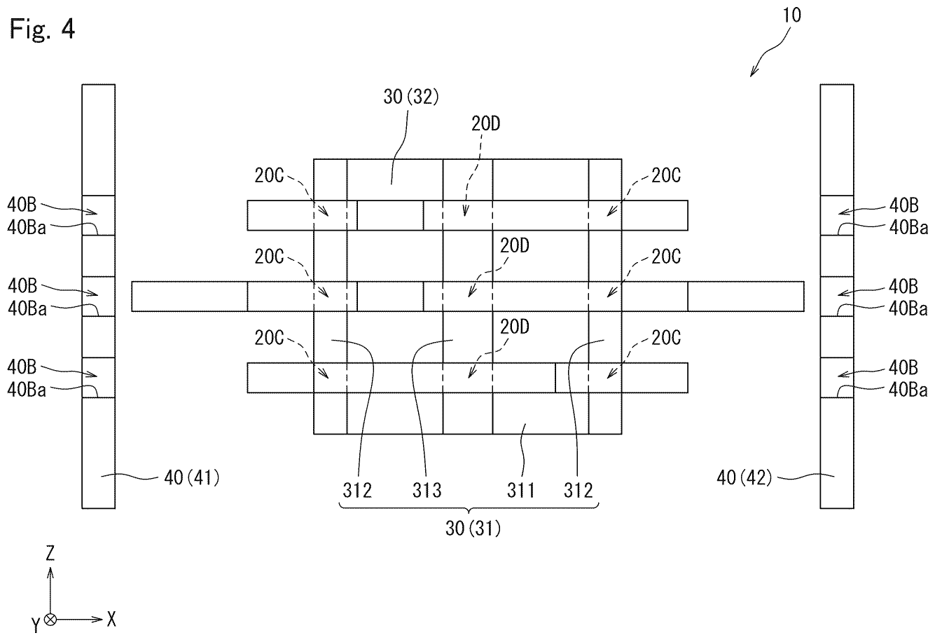

FIG. 1 is a perspective view schematically illustrating a coil component according to one embodiment of the present disclosure. FIG. 2 is an exploded perspective view of the coil component illustrated in FIG. 1. FIG. 3 is a front view of the coil component illustrated in FIG. 1. FIG. 4 is a front view of the coil component illustrated in FIG. 3 in which a support member is exploded from other parts. In the following description, when directions are indicated, X, Y, and Z directions illustrated in the drawings are used. An X direction, a Y direction, and a Z direction indicate directions of respective arrows in the drawings, and a direction opposite to the X direction, a direction opposite to the Y direction, and a direction opposite to the Z direction indicate directions opposite to the respective arrows in the drawings.

As illustrated in FIG. 1, a core material 30 is disposed on a plurality of substrates 20 in a coil component 10. In the present embodiment, the coil component 10 is a transformer.

Note that the coil component 10 is not limited to a transformer as long as the core material 30 is disposed on the plurality of substrates 20. For example, the coil component 10 may be a choke coil.

As illustrated in FIGS. 1 to 4, the coil component 10 includes the plurality of substrates 20, the core material 30 disposed on the plurality of substrates 20, and a support member 40 that supports the plurality of substrates 20.

In the present embodiment, the coil component 10 includes three substrates 20 (substrate 21, substrate 22, and substrate 23). However, the number of substrates 20 included in the coil component 10 is not limited to three. The coil component 10 may include two substrates 20, or may include four or more substrates 20. In the following description, the substrate 21, the substrate 22, and the substrate 23 are also collectively referred to as a substrate 20.

Each of the substrates 21, 22, and 23 includes a base portion formed from an insulator and a conductive wiring pattern formed on at least one of a front surface or an inside of the base portion. The base portion is formed from, for example, ceramic, glass epoxy, paper phenol, or the like. The wiring pattern has conductivity, and is formed from metal such as copper, for example.

As illustrated in FIGS. 1 and 3, the substrates 20 are disposed with a gap 20A in the order of the substrates 22, 23, and 21 along the Z direction. The Z direction is an example of a thickness direction of the substrate 20. The gap 20A between the substrates 22 and 23 and the gap 20A between the substrates 23 and 21 may be equal or different.

As illustrated in FIG. 2, each of the substrates 21, 22, and 23 includes four protrusions 24. Two of the four protrusions 24 protrude in the X direction from a side surface (a part of an outer surface 20B to be described below) that forms an end portion in the X direction of each of the substrates 21, 22, and 23, and are included with a gap 24A therebetween in the Y direction. The other two of the four protrusions 24 protrude in the direction opposite to the X direction from an end portion in the direction opposite to the X direction of each of the substrates 21, 22, and 23, and are included with the gap 24A therebetween in the Y direction.

Each of the substrates 21, 22, and 23 includes through holes 20C and 20D that the core material 30 penetrates. The through hole 20D is included at a central portion of each of the substrates 21, 22, and 23. The through holes 20C are included on both sides of the through hole 20D in the X direction. In other words, one of the through holes 20C is located on the X direction side with respect to the through hole 20D, and the other of the through holes 20C is located on a side in the direction opposite to the X direction with respect to the through hole 20D. In other words, the two through holes 20C sandwich the through hole 20D in the X direction. In the present embodiment, each of the through holes 20C is connected to the gap 24A between two protrusions 24.

Each of the substrates 21, 22, and 23 includes a coil pattern 25 that forms a coil. The coil pattern 25 corresponds to at least a part of the wiring pattern described above. Although not illustrated, each of the substrates 21, 22, and 23 may include a wiring pattern other than the coil pattern 25.

The coil pattern 25 is included on the front surface of each of the substrates 21, 22, and 23, and is connected to a wiring pattern (not illustrated) included inside each of the substrates 21, 22, and 23 by a via 26. The via 62 has conductivity. The via 62 is formed by stacking metal such as copper on an inner surface that forms a hole included in each of the substrates 21, 22, and 23 along the Z direction. The hole may or may not penetrate each of the substrates 21, 22, and 23. The coil pattern 25 is formed in a spiral shape around the through hole 20D of each of the substrates 21, 22, and 23.

In the present embodiment, the coil pattern 25 included on the substrate 21 and the coil pattern 25 included on the substrate 22 function as an input-side coil (primary coil) of a transformer. The substrates 21 and 22 include the primary coil and a peripheral circuit thereof. That is, the substrates 21 and 22 are primary substrates of the transformer.

In the present embodiment, the coil pattern 25 included on the substrate 23 functions as an output-side coil (secondary coil) of the transformer. The substrate 23 includes the secondary coil and a peripheral circuit thereof. That is, the substrate 23 is a secondary substrate of the transformer. The substrate 23 is larger than the substrates 21 and 22.

The configuration such as the size and shape of each of the substrates 21, 22, and 23 is not limited to the configuration illustrated in FIGS. 1 to 4. Regarding the sizes of the substrates 21, 22, and 23, for example, the substrate 23 is larger than the substrates 21 and 22 in FIGS. 1 to 4, but the substrate 23 may be smaller than the substrates 21 and 22. Regarding the shapes of the substrates 21, 22, and 23, for example, the substrates 21, 22, and 23 include protrusions 211, 221, and 231 in FIGS. 1 and 2, but the substrates 21, 22, and 23 may not include the protrusions 211, 221, and 231. For example, the coil pattern 25 may be included inside the substrates 21, 22, and 23. Further, for example, the through hole 20C and the gap 24A may not be connected to each other. In this case, the coil pattern 25 may be formed around the through hole 20C.

As illustrated in FIGS. 3 and 4, the core material 30 is disposed on three substrates 21, 22, and 23. In the present embodiment, only the core material 30 is mounted on the three substrates 21, 22, and 23, but an electronic component (for example, resistor, capacitor, inductor, or the like) other than core material 30 may be mounted.

The core material 30 is formed from a magnetic material. The core material 30 is formed from ferrite, for example. Note that the material of the core material 30 is not limited to ferrite. For example, the core material 30 may be formed from a silicon steel plate.

As illustrated in FIG. 2, the core material 30 includes a first core 31 and a second core 32. In the present embodiment, the first core 31 is an E core. The second core 32 is an I core. That is, in the present embodiment, the core material 30 is an EI core in which the first core 31 and the second core 32 are combined. Note that the first core 31 and the second core 32 are combined by a known means such as fitting, an adhesive, or a fixing tool.

The first core 31 includes a main body 311, two outer legs 312 that protrude from both end portions in the X direction of the main body 311, and a middle leg 313 that protrudes from the main body 311 between the two outer legs 312.

As illustrated in FIGS. 3 and 4, the main body 311 that is a part of the first core 31 is located on one side in the Z direction from the three substrates 21, 22, and 23. Each of the outer legs 312 penetrates the through hole 20C of each of the substrates 21, 22, and 23. The middle leg 313 penetrates the through hole 20D of each of the substrates 21, 22, and 23. Protruding distal end portions of the two outer legs 312 and the middle leg 313 are in contact with the second core 32. The second core 32 is located on the other side in the Z direction with respect to the three substrates 21, 22, and 23. As a result, the three substrates 21, 22, and 23 are sandwiched between the main body 311 of the first core 31 and the second core 32.

In the present embodiment, the first core 31 is an E core and the second core 32 is an I core, but may be reversed. That is, the first core 31 may be an I core, and the second core 32 may be an E core. In this case, while the entire first core 31 is located on one side in the Z direction with respect to the substrate 20, a part of the second core 32 is located on the other side in the Z direction with respect to the substrate 20.

As described above, at least a part of the first core 31 is located on one side in the Z direction with respect to the plurality of substrates 20, and at least a part of the second core 32 is located on the other side in the Z direction with respect to the plurality of substrates 20.

The configuration of the core material 30 is not limited to the configuration illustrated in FIGS. 1 to 4. For example, the first core 31 may be an E core, and the second core 32 may also be an E core. That is, the core material 30 is not limited to an EI core, and may be an EE core. The type of the core material 30 may be various types (for example, EIR core, UI core, or the like) other than those described above.

As illustrated in FIGS. 1 to 4, the support member 40 is engaged with an outer peripheral portion of each of the three substrates 21, 22, and 23 to support the three substrates 21, 22, and 23 so as to maintain the gap 20A between the substrates 22 and 23 and the gap 20A between the substrates 23 and 21.

The outer peripheral portion is an outer surface 20B of the substrates 21, 22, and 23 and a portion in the vicinity of the outer surface 20B of the substrates 21, 22, and 23 in the substrates 21, 22, and 23. The outer surface 20B is a surface that forms outer peripheries of the substrates 21, 22, and 23. For example, surfaces that form the through hole 20C are included in the outer surface 20B. The portion in the vicinity of the outer surface 20B is, for example, the protrusions 24 or the protrusions 211, 221, and 231 described above. That is, the protrusions 24 and the protrusions 211, 221, and 231 are included in the outer peripheral portion. Furthermore, for example, the portion in the vicinity of the outer surface 20B may be a portion of the substrate 20 closer to the outer surface 20B of the substrate 20 than to the center of the substrate 20 in a plan view viewed from the Z direction. Furthermore, for example, the portion in the vicinity of the outer surface 20B may be a portion of the substrate 20 in which the distance from the outer surface 20B of the substrate 20 is ⅛ or less of the distance from the outer surface 20B of the substrate 20 to the center of the substrate 20 in a plan view viewed from the Z direction.

The material of the support member 40 is any material. In the present embodiment, the support member 40 is formed from resin.

As illustrated in FIGS. 1 to 4, the support member 40 includes a first support portion 41 and a second support portion 42. Each of the first support portion 41 and the second support portion 42 has a plate shape.

The first support portion 41 is in contact with the substrates 20 from one side in the X direction. The second support portion 42 is in contact with the substrates 20 from the other side in the X direction. That is, the first support portion 41 and the second support portion 42 sandwich the three substrates 21, 22, and 23 from both sides in the X direction. The X direction is a direction intersecting the Z direction. In the present embodiment, the X direction is a direction orthogonal to the Z direction. The X direction is an example of an intersecting direction.

As illustrated in FIGS. 2 and 4, each of the first support portion 41 and the second support portion 42 includes three sets of pairs of cutouts 40B including two cutouts 40B. That is, each of the first support portion 41 and the second support portion 42 includes six cutouts 40B.

A pair of cutouts 40B is formed at the same position in the Z direction. One cutout of the pair of cutouts 40B is obtained by cutting out in the Y direction from the outer surface 40A that faces the direction opposite to the Y direction. The other cutout of the pair of cutouts 40B is obtained by cutting out in the direction opposite to the Y direction from the outer surface 40A that faces the Y direction. Each set of the pairs of cutouts 40B is formed side by side along the Z direction. The interval between two sets of pairs of cutouts 40B adjacent to each other in the Z direction is the same as the gap 20A between the two substrates 20 described above.

The protrusions 24 of the three substrates 21, 22, and 23 are fitted into three sets of pairs of respective cutouts 40B. That is, the protrusions 24 are engaged with the cutouts 40B. At this time, each of the protrusions 24 is one of surfaces that form the cutout 40B, and is supported by a support surface 40Ba that faces the Z direction. Support surfaces 40Ba form the respective cutouts 40B. That is, one support surface 40Ba of the three sets of pairs of cutouts 40B supports the substrate 21. Furthermore, another support surface 40Ba of the three sets of pairs of cutouts 40B supports the substrate 22. Furthermore, the remaining one support surface 40Ba of the three sets of pairs of cutouts 40B supports the substrate 23.

As illustrated in FIG. 2, the support member 40 includes a wiring pattern 61 and vias 62 and 63. In the present embodiment, the wiring pattern 61 and the vias 62 and 63 are included in the second support portion 42 of the support member 40.

The wiring pattern 61 has conductivity similarly to the wiring pattern such as the coil pattern 25 of the substrate 20, and is formed from metal such as copper, for example. The vias 62 and 63 have conductivity. Each of the vias 62 and 63 is formed by stacking metal such as copper on an inner surface that forms a hole included in the support member 40. Each of the vias 62 and 63 is an example of a wiring pattern.

In the present embodiment, the wiring pattern 61 is formed on a front surface 42C of the second support portion 42. The via 62 is included in a hole formed in the front surface 42C and is electrically connected to the wiring pattern 61. The wiring pattern 61 is connected to a wiring pattern (not illustrated) included inside the support member 40 by the via 62.

At least one of the wiring pattern 61 or the via 62 is electrically connected to a wiring pattern included on the substrate 21 and a wiring pattern included on the substrate 23. As a result, the substrate 21 and the substrate 23 are electrically connected via at least one of the wiring pattern 61 or the via 62.

In the present embodiment, the via 63 is included in a through hole that penetrates the second support portion 42 in the Z direction. One end portion of the via 63 is opened on the support surface 40Ba of the cutout 40B that supports the substrate 23, and is electrically connected to the wiring pattern included on the substrate 23. The other end portion of the via 63 is opened on a surface that faces the support surface 40Ba of the cutout 40B that supports the substrate 22 in the Z direction, and is electrically connected to the wiring pattern included on the substrate 22. As a result, the substrate 23 and the substrate 22 are electrically connected via the via 63.

In the present embodiment, the wiring pattern 61 is formed on the front surface of the support member 40, but may be included inside the support member 40. In this case, for example, the wiring pattern inside the support member 40 is exposed to the outside of the support member 40 via a via, and is electrically connected to the substrate 20 via the via.

In the present embodiment, the substrates 21 and 23 are electrically connected via the wiring pattern, and the substrates 23 and 22 are electrically connected via a via, but the present invention is not limited to such a configuration. For example, contrary to the above, the substrates 21 and 23 may be electrically connected via a via, and the substrates 23 and 22 may be electrically connected via a wiring pattern.

In the present embodiment, the wiring pattern 61 and the vias 62 and 63 are included in the second support portion 42, but the present invention is not limited to such a configuration. For example, the wiring pattern 61 and the vias 62 and 63 may be included in the first support portion 41. For example, the wiring pattern 61 and the via 62 may be included in the first support portion 41, and the via 63 may be included in the second support portion 42.

As illustrated in FIG. 3, the three substrates 20 are bonded to the support member 40 via an adhesive 50. More specifically, the side surfaces of the three substrates 21, 22, and 23 that face the direction opposite to the X direction are bonded to the first support portion 41 via the adhesive 50. The side surfaces of the three substrates 21, 22, and 23 that face the X direction are bonded to the second support portion 42 via the adhesive 50.

Only some of the three substrates 21, 22, and 23 may be bonded to the support member 40 via the adhesive 50. The three substrates 21, 22, and 23 may not be bonded to the support member 40 via the adhesive 50.

The core material 30 is bonded to the support member 40 via the adhesive 50. More specifically, a side surface that faces the direction opposite to the X direction of each of the main body 311 of the first core 31, the outer leg 312 of the two outer legs 312 of the first core 31 on the side opposite to the X direction, and the second core 32 is bonded to the first support portion 41 via the adhesive 50. A side surface that faces the X direction of each of the main body 311 of the first core 31, the outer leg 312 of the two outer legs 312 of the first core 31 on the X direction side, and the second core 32 is bonded to the second support portion 42 via the adhesive 50.

Note that the core material 30 may not be bonded to the support member 40 via the adhesive 50.

According to the present embodiment, the support member 40 is engaged with outer peripheral portions (protrusions 24 in the present embodiment) of the plurality of substrates 20 to support the plurality of substrates 20 so as to maintain the gap 20A between the plurality of substrates 20. Since the support member 40 is engaged with the outer peripheral portions of the plurality of substrates 20, a usable space (for example, space for disposing the core material 30 or space for forming a wiring pattern) in the plurality of substrates 20 can be increased. Furthermore, deviation of relative positions between the plurality of substrates 20 can be reduced. By the deviation of the relative positions between the plurality of substrates 20 being reduced, deviation of relative positions between the plurality of substrates 20 and the core material 30 is also reduced. As a result, wobbling of the coil component 10 can be reduced, and the coil component 10 can be stabilized.

According to the present embodiment, each of the plurality of substrates 20 is supported by the support member 40 (first support portion 41 and second support portion 42) on both sides in the X direction. As a result, the stability of the plurality of substrates 20 can be improved.

According to the present embodiment, the plurality of substrates 20 can be supported by various structures including a support surface, for example, a groove, a through hole, and the like included in the support member 40 (cutout 40B included in the support member 40 in the present embodiment).

According to the present embodiment, the support member 40 can support the plurality of substrates 20 by a simple configuration of the cutouts 40B and the protrusions 24.

According to the present embodiment, since the support member 40 has a plate shape, the thickness of the support member 40 is thin. As a result, since the thickness of the support member 40 is thin, the coil component 10 can be reduced in size and weight.

According to the present embodiment, the core material 30 includes the first core 31 and the second core 32. Accordingly, by the first core 31 being disposed on the substrate 20 and then the second core 32 being combined with the first core 31, sandwiching the plurality of substrates 20 between the first core 31 and the second core 32 is facilitated.

According to the present embodiment, the plurality of substrates 20 can be electrically connected via the wiring pattern (the wiring pattern 61 and the via 63) included in the support member 40. Therefore, it is unnecessary to separately include a configuration for electrically connecting the plurality of substrates 20, for example, to include a communication line that connects the plurality of substrates 20 separately from the support member 40.

According to the present embodiment, the plurality of substrates 20 is fixed to the support member 40 by the adhesive 50. As a result, positional displacement of the plurality of substrates 20 can be reduced as compared with a configuration in which the support member 40 and the plurality of substrates 20 are not bonded via the adhesive 50.

According to the present embodiment, the core material 30 is fixed to the support member 40 by the adhesive 50. As a result, positional displacement of the core material 30 with respect to the support member 40 can be reduced as compared with a configuration in which the support member 40 and the core material 30 are not bonded via the adhesive 50.

The configuration of the support member 40 is not limited to the configuration illustrated in FIGS. 1 to 4.

For example, the shape of the first support portion 41 and the second support portion 42 is not limited to a plate shape, and may be a non-plate shape such as a rectangular parallelepiped shape.

The support member 40 illustrated in FIGS. 1 to 4 includes the cutouts 40B that are engaged with the substrates 20. However, the configuration of the support member 40 for engaging the substrates 20 is not limited to the cutouts 40B.

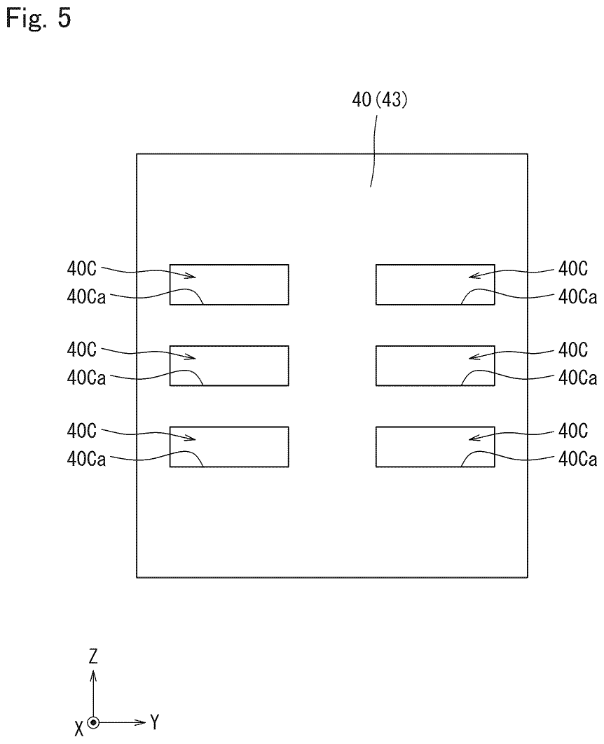

For example, the support member 40 may include a support portion 43 as illustrated in FIG. 5 instead of at least one of the first support portion 41 or the second support portion 42.

FIG. 5 is a side view schematically illustrating a support member of a modification. The support portion 43 includes three sets of pairs of through holes 40C instead of the three sets of pairs of cutouts 40B. Each of the through holes 40C penetrates the support portion 43 in the X direction. The through holes 40C are included at positions corresponding to the respective cutouts 40B.

The protrusions 24 of the three substrates 21, 22, and 23 are fitted into the respective through holes 40C. That is, the protrusions 24 are engaged with the through holes 40C. At this time, each of the protrusions 24 is one of surfaces that form the through hole 40C, and is supported by a support surface 40Ca that faces the Z direction. Support surfaces 40Ca form the respective through holes 40C. That is, one set of support surfaces 40Ca of the three sets of pairs of through holes 40C supports the substrate 21. Furthermore, another set of support surfaces 40Ca of the three sets of pairs of through holes 40C supports the substrate 22. Furthermore, the remaining one set of support surfaces 40Ca of the three sets of pairs of through holes 40C supports the substrate 23.

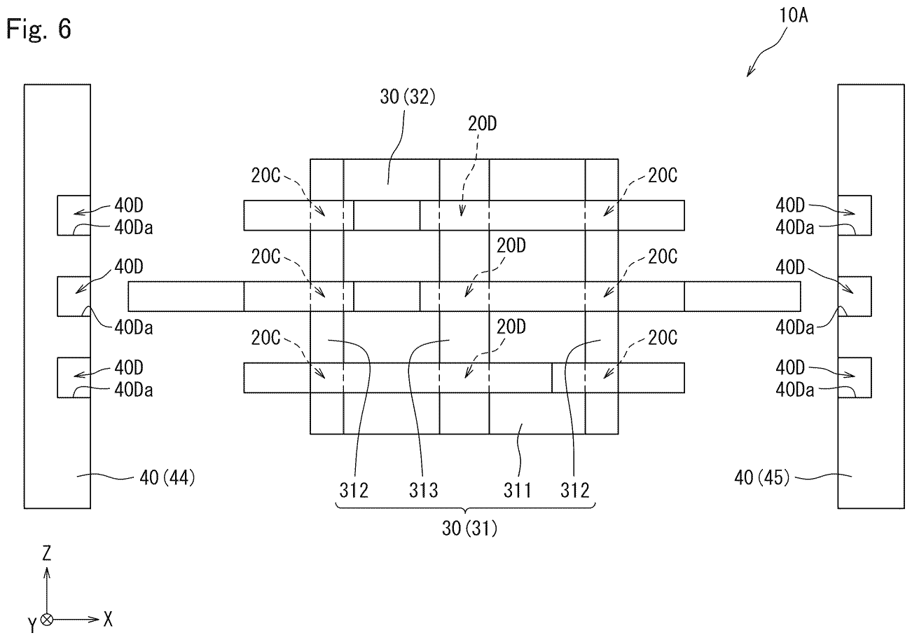

Furthermore, for example, as illustrated in FIG. 6, the coil component 10A may include support portions 44 and 45 instead of the first support portion 41 and the second support portion 42. FIG. 6 is a front view in which a support member is replaced with a support member of a modification in the front view of FIG. 3. Each of the support portions 44 and 45 includes three sets of pairs of recesses 40D instead of the three sets of pairs of cutouts 40B. Each of the recesses 40D is included on a surface that faces the substrates 20 among outer surfaces of the support portions 44 and 45, and is recessed from the surface along the X direction. The recesses 40D correspond to the respective cutouts 40B.

The protrusions 24 of the three substrates 21, 22, and 23 are fitted into the respective recesses 40D. That is, the protrusions 24 are engaged with the recesses 40D. At this time, each of the protrusions 24 is one of surfaces that form the recess 40D, and is supported by a support surface 40Da that faces the Z direction. Support surfaces 40Da form the respective recesses 40D. That is, one set of support surfaces 40Da of the three sets of pairs of recesses 40D supports the substrate 21. Furthermore, another set of support surfaces 40Da of the three sets of pairs of through holes 40C supports the substrate 22. Furthermore, the remaining one set of support surfaces 40Da of the three sets of pairs of through holes 40C supports the substrate 23.

The recesses 40D may not correspond to the cutouts 40B. For example, each of the support portions 44 and 45 may include one recess elongated in the Y direction instead of a pair of recesses 40D. That is, each of the support portions 44 and 45 may include three recesses arranged in the Z direction instead of the three sets of pairs of recesses 40D. The length of each of the recesses in the Y direction is the length of each of the substrates 21, 22, and 23 in the Y direction or longer. As a result, the entire areas of end portions of the substrates 21, 22, and 23 in the X direction are fitted into the recesses. In this case, even if the substrates 21, 22, and 23 do not include the protrusions 24, the support portions 44 and 45 can support the substrates 21, 22, and 23 by the recesses.

The coil component 10A illustrated in FIG. 6 includes the support portions 44 and 45 instead of the first support portion 41 and the second support portion 42. However, for example, the coil component may include the second support portion 42 while including the support portion 44 instead of the first support portion 41. That is, the coil component may include the support portion 44 and the second support portion 42. Furthermore, for example, the coil component may include the first support portion 41 while including the support portion 45 instead of the second support portion 42. That is, the coil component may include the support portion 45 and the first support portion 41.

The support member 40 illustrated in FIGS. 1 to 4 includes the first support portion 41 and the second support portion 42, and the first support portion 41 and the second support portion 42 sandwich the three substrates 20 from both sides in the X direction. However, the configuration of the support member 40 is not limited to such a configuration.

For example, the support member 40 may include only one of the first support portion 41 and the second support portion 42. In this case, the support member 40 supports the substrates 20 only on one side in the X direction, but a known structure (for example, columnar member for supporting the substrates 20) that is not the support member 40 supports the substrates 20 on the other side in the X direction.

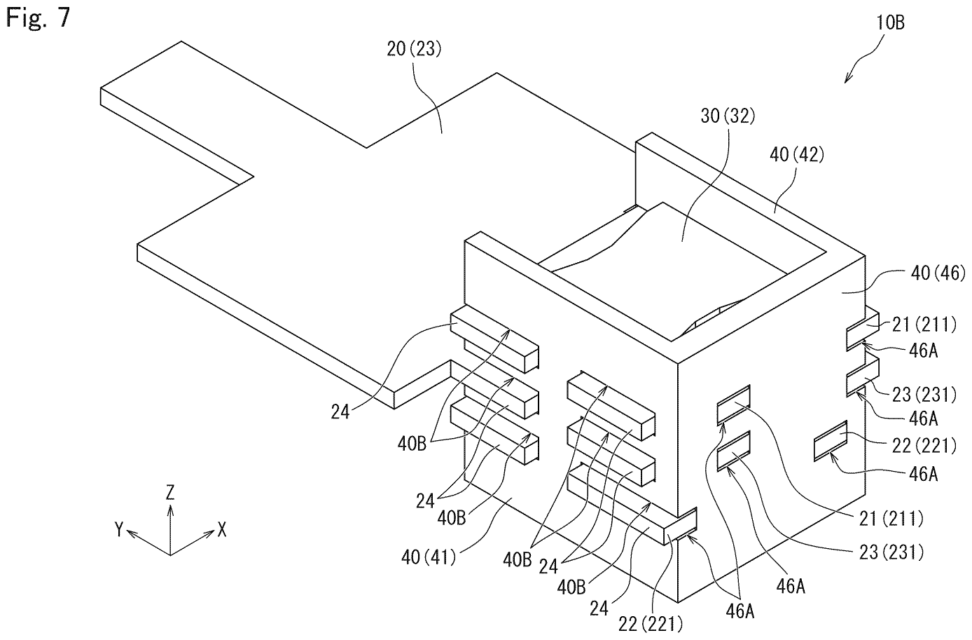

Furthermore, for example, as illustrated in FIG. 7, the coil component 10B may include the support member 40 in which the first support portion 41, the second support portion 42, and a third support portion 46 are integrally formed. FIG. 7 is a perspective view schematically illustrating a coil component of a modification according to the one embodiment of the present disclosure.

The first support portion 41 is in contact with the substrates 20 from one side in the X direction. The second support portion 42 is in contact with the substrates 20 from the other side in the X direction.

The third support portion 46 is in contact with the substrates 20 along the Y direction. End portions of the third support portion 46 in the X direction are connected to the first support portion 41 and the second support portion 42.

The third support portion 46 includes six through holes 46A. Each of the through holes 46A penetrates the third support portion 46 in the Y direction. The protrusions 211 of the substrate 21 are fitted into two of the six through holes 46A. The protrusions 231 of the substrate 23 are fitted into other two of the six through holes 46A. The protrusions 221 of the substrate 22 are fitted into the remaining two of the six through holes 46A.

The material of the support member 40 is not limited to resin. For example, the support member 40 may be formed from metal such as iron.

In a case where the support member 40 is formed from metal, heat generated in the plurality of substrates 20 and heat generated in the core material 30 can be dissipated through the support member 40 formed from metal.

The above description can also be expressed as follows.
(1) A coil component 10 according to one aspect of the present disclosure includes: a plurality of substrates 20 (substrate 21, 22, and 23) each including a coil pattern 25 and stacked with a gap 20A along a thickness direction (Z direction); a core material 30 disposed on the plurality of substrates 20; and a support member 40 that is engaged with an outer peripheral portion of the plurality of substrates 20 to support the plurality of substrates 20 so as to maintain the gap 20A.
(2) In the coil component 10 according to (1), the support member may include a first support portion 41 and a second support portion 42 that sandwich the plurality of substrates 20 from both sides in an intersecting direction (X direction) intersecting the thickness direction (Z direction).
(3) In the coil component 10 according to (1) or (2), the support member 40 may include support surfaces 40Ba that face the thickness direction (Z direction) and support the plurality of substrates 20.
(4) In the coil component 10 according to any one of (1) to (3), the support member 40 may include a cutout 40B obtained by cutting out from an outer surface 40A of the support member 40, and each of the plurality of substrates 20 may include a protrusion 24 that protrudes from a side surface of each of the plurality of substrates 20 and is engaged with the cutout 40B.
(5) In the coil component 10 according to any one of (1) to (4), the support member 40 may have a plate shape.
(6) In the coil component 10 according to any one of (1) to (5), the core material 30 may include a first core 31 and a second core 32 that are in contact with each other, at least a part of the first core 31 may be located on one side in the thickness direction (Z direction) with respect to the plurality of substrates 20, and at least a part of the second core 32 may be located on another side in the thickness direction (Z direction) with respect to the plurality of substrates 20.
(7) In the coil component 10 according to any one of (1) to (6), the support member 40 may be formed from metal.
(8) In the coil component 10 according to any one of (1) to (7), the support member 40 may include a conductive wiring pattern (wiring pattern 61 and vias 62 and 63).
(9) In the coil component 10 according to any one of (1) to (8), at least one of the plurality of substrates 20 and the support member 40 may be bonded via an adhesive 50.
(10) In the coil component 10 according to any one of (1) to (9), the core material 30 and the support member 40 may be bonded via an adhesive 50.

Note that, by any embodiments among the various embodiments described above being appropriately combined, the effects of the respective embodiments can be achieved.

Although the present disclosure has been sufficiently described in connection with preferred embodiments with reference to the drawings as appropriate, various modifications and corrections will be apparent to those skilled in the art. Such variations and modifications should be understood to be included within the scope of the present invention according to the appended claims as long as they do not depart therefrom.

### REFERENCE SIGNS LIST

10 Coil component
20 Substrate
20A Gap
24 Protrusion
25 Coil pattern
30 Core material
31 First core
32 Second core
40 Support member
40A Outer surface
40B Cutout
40Ba Support surface
41 First support portion
42 Second support portion
50 Adhesive
61 Wiring pattern
63 Via (wiring pattern)

1. A coil component comprising:
a plurality of substrates each comprising a coil pattern and disposed with a gap there between along a thickness direction;
a core material disposed on the plurality of substrates; and
a support member engaged with an outer peripheral portion of the plurality of substrates to support the plurality of substrates by maintaining the gap.

2. The coil component according to claim 1, wherein
the support member comprises a first support portion and a second support portion sandwiching the plurality of substrates from both sides in an intersecting direction intersecting the thickness direction.

3. The coil component according to claim 1, wherein
the support member comprises support surfaces facing the thickness direction and supporting the plurality of substrates.

4. The coil component according to claim 1, wherein
the support member comprises a cutout obtained by cutting out from an outer surface of the support member, and
each of the plurality of substrates comprise a protrusion protruded from a side surface of each of the plurality of substrates and engaged with the cutout.

5. The coil component according to claim 1, wherein
the support member has a plate shape.

6. The coil component according to claim 1, wherein
the core material comprises a first core and a second core being in contact with each other,
at least a part of the first core is located on one side in the thickness direction with respect to the plurality of substrates, and
at least a part of the second core is located on another side in the thickness direction with respect to the plurality of substrates.

7. The coil component according to claim 1, wherein
the support member is formed from metal.

8. The coil component according to claim 1, wherein
the support member comprises a conductive wiring pattern.

9. The coil component according to claim 1, wherein
at least one of the plurality of substrates and the support member are bonded via an adhesive.

10. The coil component according to claim 1, wherein
the core material and the support member are bonded via an adhesive.
